(19) United States
(12) Patent Application Publication
(10) Pub. No.: US 2005/0155625 A1
(43) Pub. Date: Jul. 21, 2005

(54) Chamber cleaning method

(75) Inventors: Shiu-Ko Jangjian, Fengshan City (TW); Sheng-Wen Chen, Shinjuang City (TW); Hung-Jui Chang, Shetou Shiang (TW); Chen-Liang Chang, Hsinchu City (TW); Ying-Lang Wang, Lungjing Shiang (TW)

Correspondence Address: TUNG & ASSOCIATES, Suite 120, 838 W. Long Lake Road, Bloomfield Hills, MI, 48302, US

(73) Assignee: Taiwan Semiconductor Manufacturing Co., Ltd.

(21) Appl. No.: 10/761,654

(22) Filed: Jan. 20, 2004

(51) Int. Cl. B08B 7/02; B08B 9/00

(52) U.S. Cl. 134/1.1; 134/22.1

(57) ABSTRACT

A method suitable for cleaning the interior surfaces of a process chamber is disclosed. The invention is particularly effective in removing silicon nitride and silicon dioxide residues from the interior surfaces of a chemical vapor deposition (CVD) chamber. The method includes reacting nitrous oxide (N₂O) gas with nitrogen trifluoride (NF₃) gas in a plasma to generate nitric oxide (NO) and fluoride (F) radicals. Due to the increased density of nitric oxide radicals generated from the nitrous oxide, the etch and removal rate of the residues on the interior surfaces of the chamber is enhanced. Consequently, the quantity of nitrogen trifluoride necessary to efficiently and expeditiously carry out the chamber cleaning process is reduced.

### FIELD OF THE INVENTION

The present invention generally relates to techniques for cleaning residues from interior surfaces of a process chamber. More particularly, the present invention relates to a novel chamber cleaning method in which nitrous oxide gas is reacted with nitrogen tri-fluoride gas to generate etchant chamber-cleaning nitric oxide and fluoride radicals.

### BACKGROUND OF THE INVENTION

In the semiconductor production industry, various processing steps are used to fabricate integrated circuits on a semiconductor wafer. These steps include the deposition of layers of different materials including metallization layers, passivation layers and insulation layers on the wafer substrate, as well as photoresist stripping and sidewall passivation polymer layer removal. In modern memory devices, for example, multiple layers of metal conductors are required for providing a multi-layer metal interconnection structure in defining a circuit on the wafer. Chemical vapor deposition (CVD) processes are widely used to form layers of materials on a semiconductor wafer.

CVD processes include thermal deposition processes, in which a gas is reacted with the heated surface of a semiconductor wafer substrate, as well as plasma-enhanced CVD processes, in which a gas is subjected to electromagnetic energy in order to transform the gas into a more reactive plasma. Forming a plasma can lower the temperature required to deposit a layer on the wafer substrate, to increase the rate of layer deposition, or both. However, in plasma process chambers used to carry out these various CVD processes, materials such as polymers are coated onto the chamber walls and other interior chamber components and surfaces during the processes. These polymer coatings frequently generate particles which inadvertently become dislodged from the surfaces and contaminate the wafers.

In semiconductor production, the quality of the integrated circuits on the semiconductor wafer is directly correlated with the purity of the fabricating processes, which in turn depends upon the cleanliness of the manufacturing environment. Furthermore, technological advances in recent years in the increasing miniaturization of semiconductor circuits necessitate correspondingly stringent control of impurities and contaminants in the plasma process chamber. When the circuits on a wafer are submicron in size, the smallest quantity of contaminants can significantly reduce the yield of the wafers. For instance, the presence of particles during deposition or etching of thin films can cause voids, dislocations, or short-circuits which adversely affect performance and reliability of the devices constructed with the circuits.

Over the years, particle and film contamination in the semiconductor industry has been significantly reduced by improving the quality of clean rooms, using automated equipment designed to handle semiconductor substrates, and improving techniques used to clean the substrate surfaces. However, deposit of material such as silicon nitride and silicon dioxide residues on the interior surfaces of the processing chambers remains a problem. Accordingly, various techniques for the in-situ cleaning of process chambers have been developed in recent years.

Cleaning gases such as nitrogen trifluoride, chlorine trifluoride, hexafluoroethane, sulfur hexafluoride and carbon tetrafluoride and mixtures thereof have been used in various cleaning applications. These gases are introduced into a process chamber at a predetermined temperature and pressure for a desirable length of time to clean the surfaces inside a process chamber. However, these cleaning techniques are not always effective in cleaning or dislodging all the film and particle contaminants coated on the chamber walls. The smallest quantity of contaminants remaining in the chamber after such cleaning processes can cause significant problems in subsequent manufacturing cycles.

Until recently, fluorocarbon gases (CₓF_{y}) were extensively used to remove residues from the interior surfaces of process chambers. In an ionizing plasma, fluorocarbon gas dissociates into carbon dioxide and fluoride radicals. However, fluorocarbon gases exert a considerable global warming potential (GWP) effect on the environment. Increasingly, governments and international treaties are requiring that the venting of high-GWP chemicals be reduced or eliminated. Consequently, alternatives to fluorocarbons as a chamber cleaning gas in the semiconductor fabrication industry are currently being sought.

One of the compounds which is currently used as an alternative to fluorocarbons to clean process chambers, particularly CVD chambers, is nitrogen trifluoride (NF₃). Typically, the nitrogen trifluoride is mixed with oxygen and argon and introduced into the chamber as a gas mixture. In the plasma atmosphere in the process chamber, the nitrogen trifluoride dissociates into fluoride radicals which etch the silicon nitride or silicon dioxide residues from the interior surfaces of the chamber.

While the cleaning efficiency of nitrogen trifluoride is satisfactory, the cost of nitrogen trifluoride is nearly four times that of fluorocarbons. Furthermore, the etch rate of nitrogen trifluoride is relatively slow (less than about 5,000 angstroms/min. in the removal of silicon carbides and/or organosilicates from the interior surfaces of process chambers). Accordingly, a method is needed which facilitates the efficient and cost-effective use of nitrogen trifluoride in the cleaning of a process chamber.

An object of the present invention is to provide a novel method suitable for cleaning the interior surfaces of a process chamber.

Another object of the present invention is to provide a novel method which augments the cleaning effect of nitrogen trifluoride in the cleaning of a process chamber.

Still another object of the present invention is to provide a novel method which reduces the quantity of nitrogen trifloride needed to effectively clean a process chamber. Yet another object of the present invention is to provide a novel chamber cleaning method which is efficient and inexpensive.

A still further object of the present invention is to provide a novel chamber cleaning method which includes reacting nitrous oxide gas with nitrogen trifluoride to generate nitric oxide and fluoride radicals that remove silicon nitride and/or silicon dioxide residues from interior surfaces of a process chamber.

Yet another object of the present invention is to provide a novel chamber cleaning method which is capable of expediting the chamber cleaning time.

Another object of the present invention is to provide a novel chamber cleaning method which is applicable to cleaning various types of processing chambers.

### SUMMARY OF THE INVENTION

In accordance with these and other objects and advantages, the present invention is generally directed to a novel method which is suitable for cleaning the interior surfaces of a process chamber. The present invention is particularly effective in removing silicon nitride and silicon dioxide residues from the interior surfaces of a chemical vapor deposition (CVD) chamber. The method includes reacting nitrous oxide (N₂O) gas with nitrogen trifluoride (NF₃) gas in a plasma to generate nitric oxide (NO) and fluoride (F) radicals. Due to the increased density of nitric oxide radicals generated from the nitrous oxide, the etch and removal rate of the residues on the interior surfaces of the chamber is enhanced. Consequently, the quantity of nitrogen trifluoride necessary to efficiently and expeditiously carry out the chamber cleaning process is reduced.

### BRIEF DESCRIPTION OF THE DRAWINGS

The invention will now be described, by way of example, with reference to the accompanying drawings, in which:

FIG. 1 is a schematic of a typical conventional process chamber in implementation of the present invention;

FIG. 2 is a flow diagram illustrating a sequential flow of process steps according to a typical method of the present invention; and

FIG. 3 is a graph wherein etch rates of silicon nitride (on the Y-axis) is plotted as a function of increasing volume ratios of nitrous oxide/nitrogen trifluoride (on the X-axis) according to the method of the present invention.

### DETAILED DESCRIPTION OF THE INVENTION

The present invention has particularly beneficial utility in the removal of material residues from the interior surfaces of a CVD process chamber used in the deposition of material layers on a semiconductor wafer substrate. However, the invention is not so limited in application, and while references may be made to such CVD process chamber, the invention is more generally applicable to removing residues from the interior surfaces of etch chambers and other process chambers used in the fabrication of integrated circuits on semiconductor wafer substrates.

The present invention contemplates a novel method suitable for cleaning the interior surfaces of a process chamber such as a chemical vapor deposition (CVD) chamber. The method includes reacting nitrous oxide (N₂O) with nitrogen trifluoride (NF₃) in a plasma to generate nitric oxide (NO) and fluoride (F) radicals in the process chamber. The increased density of nitric oxide radicals generated from the nitrous oxide and nitrogen trifluoride enhances and expedites the etch and removal rate of the residues on the interior surfaces of the chamber. This substantially reduces the quantity of the relatively-expensive nitrogen trifluoride which is necessary to efficiently and expeditiously carry out the chamber cleaning process.

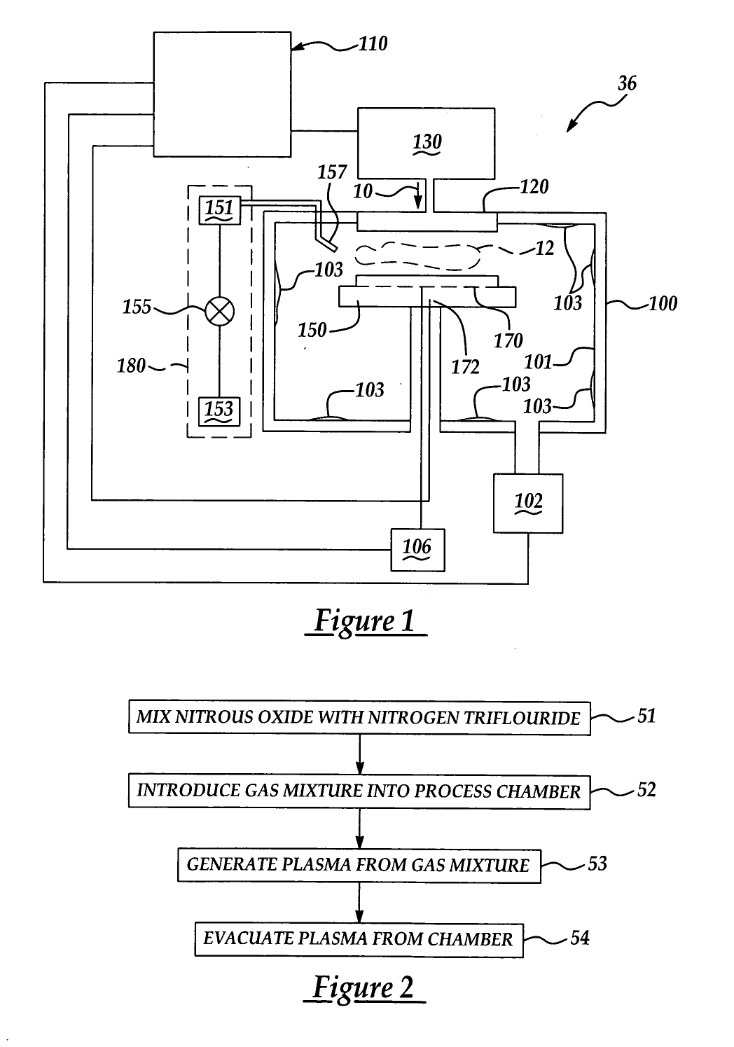

An illustrative CVD processing system 36 in implementation of the present invention is shown in FIG. 1. The CVD processing system 36 may be used to deposit various material layers, such as silicon nitride and silicon dioxide, on a semiconductor wafer. An example of a CVD processing system 36 is the DXZ.TM system, commercially available from Applied Materials, Inc., of Santa Clara, Calif. However, it is understood that the CVD processing system 36 shown in FIG. 1 is merely one example of a CVD processing system which is suitable for implementation of the present invention. Accordingly, the method of the present invention may be used to clean process chambers having features which differ from those of the CVD processing system 36 shown in FIG. 1.

The CVD processing system 36 typically includes a process chamber 100 which contains a wafer support pedestal 150. A heater element 170 may be embedded in the wafer support pedestal 150 for heating a wafer supported on the wafer support pedestal 150. An AC power supply 106 is typically connected to the heater element 170. A temperature sensor 172 is typically embedded in the wafer support pedestal 150 to monitor the temperature of the pedestal 150. The measured temperature is used in a feedback loop to control the power supplied to the heater element 170 through the AC power supply 106.

A showerhead or gas distribution plate 120 is provided in the top of the process chamber 100 for the introduction of process gases into the process chamber 100. A gas panel 130, which is used to select the gases to be introduced into the chamber 100 through the showerhead 120, is connected to the showerhead 120. A vacuum pump 102 is operably connected to the process chamber 100 to maintain proper gas flow and pressure inside the process chamber 100, as well as to evacuate reactant by-products from the process chamber 100.

A control unit 110 is operably connected to the gas panel 130 and to the various operational components of the process chamber 100, such as the vacuum pump 102 and the AC power supply 106, to control a CVD process carried out in the process chamber 100. Control of process gases flowing through the gas panel 130 is facilitated by mass flow controllers (not shown) and a microprocessor controller (not shown). In a CVD process, the showerhead 120 facilitates a uniform distribution of process gases over the surface of a substrate (not shown) supported on the support pedestal 150.

The showerhead 120 and the wafer support pedestal 150 form a pair of spaced-apart electrodes in the process chamber 100. When an electric field is generated between these electrodes, the process gases flowing into the process chamber 100 through the showerhead 120 are ignited to form a plasma. Typically, the electric field is generated by connecting the wafer support pedestal 150 to a source of RF (radio frequency) power through a matching network (not shown). Alternatively, the RF power source and the matching network may be coupled to the showerhead 120 or to both the showerhead 120 and the wafer support pedestal 150.

A remote plasma source 180 may be coupled to the process chamber 100 to provide a remotely-generated plasma to the process chamber 100. The remote plasma source 180 includes a gas supply 153, a gas flow controller 155, a plasma chamber 151 and a chamber inlet 157. The gas flow controller 155 controls the flow of process gases from the gas supply 153 to the plasma chamber 151.

A remote plasma may be generated by applying an electric field to the process gas in the plasma chamber 151, creating a plasma of reactive species. Typically, the electric field is generated in the plasma chamber 151 using an RF power source (not shown). The reactive species generated in the remote plasma source 180 are introduced into the process chamber 100 through the inlet 157.

During normal operation of the CVD processing system 36, in the chemical vapor deposition of material layers deposited on wafers (not shown) supported on the wafer support pedestal 150, material residues 103 gradually accumulate on the interior surfaces 101 of the process chamber 100. These material residues 103 include silicon nitride and silicon dioxide, for example. Particles from the residues 103 have a tendency to break off and potentially contaminate devices being fabricated on subsequent wafers processed in the chamber 100, and therefore, must be periodically removed from the interior surfaces 101 for optimum processing.

According to the method of the present invention, the silicon nitride and silicon dioxide residues 103 are removed from the interior surfaces 101 of the process chamber 100 using a nitrous oxide/nitrogen trifluoride mixture 10. The nitrous oxide/nitrogen trifluoride mixture 10 forms a plasma 12 inside the process chamber 100. In the plasma 12, the nitrous oxide reacts with the nitrogen trifluoride to form nitric oxide radicals, fluoride radicals and molecular nitrogen, according to the following formula:
N₂O+NF₃→NO*+N₂+3F*

The highly-reactive nitric oxide radicals and fluoride radicals react with and remove the silicon nitride and silicon dioxide residues 103 from the interior surfaces 101. After the cleaning process, the resulting nitrogen- and fluoride-based gases are evacuated from the process chamber 100 typically using the vacuum pump 102.

FIG. 2 illustrates a flow diagram of sequential process steps carried out according to a method of the present invention. In process step S1, nitrous oxide gas (N₂O) is mixed with nitrogen trifluoride (NF₃) gas. The nitrous oxide gas and nitrogen trifluoride gas are typically also mixed with an inert carrier gas such as argon (Ar) or helium (He). Preferably, argon is the carrier gas since argon facilitates a more efficient cleaning process as compared to helium.

The nitrous oxide and nitrogen trifluoride are present in the gas mixture 10 in a nitrous oxide:nitrogen trifluoride volume ratio of at least typically about 0.2. Preferably, the nitrous oxide:nitrogen trifloride volume ratio in the gas mixture 10 is from typically about 0.2 to about 0.8. Most preferably, the nitrous oxide and nitrogen trifluoride are present in the gas mixture 10 in a nitrous oxide:nitrogen trifloride volume ratio of typically at least about 0.8. A nitrous oxide:nitrogen trifluoride volume ratio of at least about 0.8 in the gas mixture 10 facilitates optimum etching and removal of the silicon nitride and silicon dioxide residues 103 from the interior chamber surfaces 101.

In process step S2 of FIG. 2, the gas mixture 10 (FIG. 1) is introduced into the process chamber 100. In process step S3, the plasma 12 is generated from the gas mixture 10. In general, the following process parameters can be used to generate a nitrous oxide/nitrogen trifluoride-based plasma in the process chamber 100. The process parameters range from a chamber temperature of from typically about 65 degrees C to about 300 degrees C, a chamber pressure of from typically about 1 torr to about 20 torr, a gas mixture flow rate of from typically about 5 sccm to about 500 sccm, and a radio frequency (RF) power of from typically about 1 Watt/cm² to about 20 Watts/cm².

The plasma 12 contacts the interior surfaces 101 of the process chamber 100. Nitric oxide radicals generated from the nitrous oxide, and fluoride radicals generated from the nitrogen trifluoride, etch the residues 103 from the surfaces 101. Consequently, a much smaller quantity of the relatively expensive nitrogen trifluoride gas is necessary to adequately clean the surfaces 101, than would be the case in the event that nitrogen trifluoride were the only source gas for the cleaning operation.

In process step S4, the plasma 12 is evacuated from the process chamber 100. This is facilitated by operation of the vacuum pump 102. With the residues 103 cleaned from the interior surfaces 101, the process chamber 100 is sufficiently clean to resume processing of wafers therein.

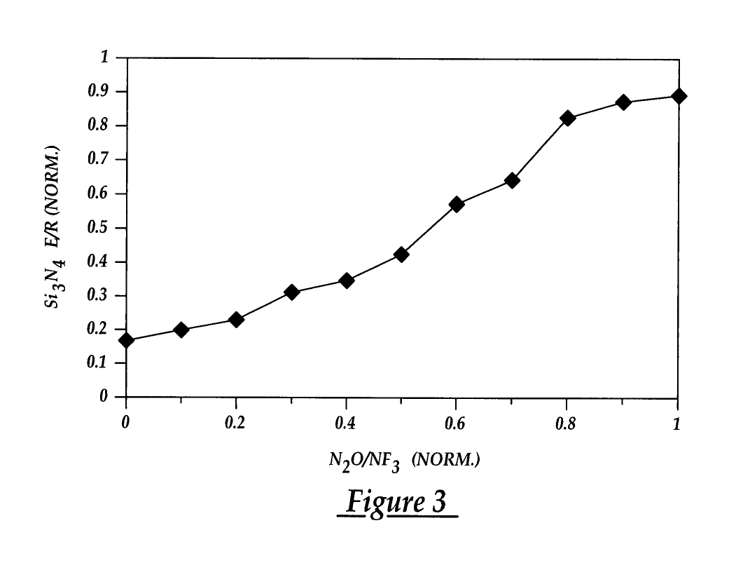

FIG. 3 illustrates a graph in which silicon nitride etch rates (increasing along the Y-axis) are plotted as a function of various volume ratios (increasing along the X-axis) of nitrous oxide:nitrogen trifluoride in the gas mixture. According to the graph, the etch rate of silicon nitride steadily increases as the proportion of nitrous oxide relative to nitrogen trifluoride in the gas mixture increases. The range of nitrous oxide:nitrogen trifluoride ratios which facilitates a cleaning process that is more expeditious than that using nitrogen trifluoride alone is from typically at least about 0.2 to typically about 0.8. The most preferable nitrous oxide:nitrogen trifluoride ratio is at least about 0.8, beyond which the silicon nitride etch and removal rate substantially levels off. As compared to the conventional chamber cleaning method using nitrogen trifluoride, the chamber cleaning method of the present invention has been shown to decrease the cleaning time by about 20%.

While the preferred embodiments of the invention have been described above, it will be recognized and understood that various modifications can be made in the invention and the appended claims are intended to cover all such modifications which may fall within the spirit and scope of the invention.

1. A method of cleaning a process chamber, comprising the steps of:
providing a gas mixture comprising nitrous oxide and nitrogen trifloride in a nitrous oxide:nitrogen trifluoride volume ratio of at least about 0.2;
introducing said gas mixture into the process chamber; and
generating a plasma from said gas mixture.

2. The method of claim 1 further comprising the step of providing an inert carrier gas in said gas mixture.

3. The method of claim 1 wherein said nitrous oxide:nitrogen trifluoride volume ratio is from at least about 0.2 to about 0.8.

4. The method of claim 3 further comprising the step of providing an inert carrier gas in said gas mixture.

5. The method of claim 2 wherein said inert carrier gas comprises argon.

6. The method of claim 5 wherein said nitrous oxide:nitrogen trifluoride volume ratio is from at least about 0.2 to about 0.8.

7. The method of claim 2 wherein said inert carrier gas comprises helium.

8. The method of claim 7 wherein said nitrous oxide:nitrogen trifluoride volume ratio is from at least about 0.2 to about 0.8.

9. A method of cleaning a process chamber, comprising the steps of:
providing a gas mixture comprising nitrous oxide and nitrogen trifloride in a nitrous oxide:nitrogen trifluoride volume ratio of at least about 0.8;
introducing said gas mixture into the process chamber; and
generating a plasma from said gas mixture.

10. The method of claim 9 further comprising the step of providing an inert carrier gas in said gas mixture.

11. The method of claim 10 wherein said inert carrier gas comprises argon.

12. The method of claim 10 wherein said inert carrier gas comprises helium.

13. A method of expediting cleaning of a process chamber using nitrogen trifluoride, comprising the steps of:
forming a gas mixture by adding nitrous oxide to the nitrogen trifluoride in a nitrous oxide:nitrogen trifluoride volume ratio of at least about 0.2;
introducing said gas mixture into the process chamber; and
forming nitric oxide radicals and fluoride radicals in the process chamber by generating a plasma from said gas mixture.

14. The method of claim 13 further comprising the step of providing an inert carrier gas in said gas mixture.

15. The method of claim 13 wherein said nitrous oxide:nitrogen trifluoride volume ratio is from at least about 0.2 to about 0.8.

16. The method of claim 15 further comprising the step of providing an inert carrier gas in said gas mixture.

17. The method of claim 13 wherein said nitrous oxide:nitrogen trifluoride volume ratio is at least about 0.8.

18. The method of claim 17 further comprising the step of providing an inert carrier gas in said gas mixture.

19. The method of claim 18 wherein said inert carrier gas comprises argon.

20. The method of claim 18 wherein said inert carrier gas comprises helium.
